(19) United States
(12) Patent Application Publication
(10) Pub. No.: US 2012/0065108 A1
(43) Pub. Date: Mar. 15, 2012

(54) FLUORINATED POLYMERIC MICROPARTICLES AND USES THEREOF AS FLUID REDUCING ADDITIVES

(76) Inventors: Tom Opstal, Laame (BE); Rudolf J. Dams, Antwerp (BE); Rudy W. Van Campenhout, Hoboken (BE); Francois C. D'Haese, Antwerp (BE)

(21) Appl. No.: 13/321,579

(22) PCT Filed: Jun. 2, 2010
(86) PCT No.: PCT/US10/37012

§ 371 Date: Nov. 21, 2011

(30) Foreign Application Priority Data
Jun. 5, 2009 (GB) 0909621.5

(51) Int. Cl. C09K 8/12; C08F 236/20; C08L 47/00

(52) U.S. Cl. 507/105; 525/200; 526/243; 428/402

(57) ABSTRACT

Fluorinated polymeric microparticles, processes for preparing them and uses thereof as additives for fluid loss control of drilling fluids and methods of fluid loss control of drilling fluid loss with fluorinated microparticles and uses of fluoropolymers as fluid loss control agents. Said fluorinated polymeric microparticles comprise one or more repeating units derived from one or more fluorinated monomers and one or more repeating units derived from one or more acrylate monomers.

### FIELD

The present invention relates to the use of fluoropolymers as additives for reducing the loss of drilling fluid in the material surrounding a borehole in a drilling process. The present invention also relates to fluorinated polymeric microparticles, processes of preparing them and their use as additives for reducing the loss of drilling fluid into the material surrounding a borehole during a drilling process. The present invention also relates to drilling fluids comprising fluoropolymers or fluorinated polymeric microparticles and to methods of reducing loss of drilling fluids in a drilling operation.

### BACKGROUND

During drilling operations, in particular drilling operations into inorganic materials, such as rock, cement or subterranean formations drilling fluids are employed to facilitate the drilling. Drilling fluids are in particular used for the production of wells for the purpose of recovering hydrocarbons and other fluid and/or gaseous materials. Typically, the drilling fluid is circulated during drilling from the surface through the interior of the drill string and the annulus between the drill string and the formation and back. Drilling fluids, also referred to as “drilling muds”, which include water-based and organic-based drilling fluids, such as oil-based and so-called synthetic-based drilling fluids, are used in the drilling of such wells. Drilling fluids typically have a number of functions including: lubricating and cooling the drilling tool and drill pipe which carries the tool; suspending and transporting formation cuttings to the surface for screening out and disposal; holding the cuttings in suspension in the event of a shutdown in the drilling and pumping of the drilling fluid; and counterbalancing formation pressures to prevent the inflow of gas, oil or water from permeable rocks which may be encountered at various levels as drilling continues. Having regard to these functions generally the drilling fluid used for a particular drilling operation is typically designed or otherwise selected to have particular rheological and density properties.

For a drilling fluid to perform the aforesaid functions and allow drilling to continue, the drilling fluid should stay in the borehole. Frequently, undesirable conditions are encountered during drilling in which small or substantial amounts of the drilling fluid may be lost to the formation surrounding the borehole. Drilling fluid can leave the borehole through large or small fissures or fractures in the formation, which may be either pre-existing or drilling-induced, or through a porous formation surrounding the borehole. The basic mechanism of fluid loss control generally involves the formation of a filter cake of varying thickness, during drilling, on the sides of the borehole and hence at the interface of the porous or permeable formation. Unfortunately, formation conditions are frequently encountered during drilling which may result in unacceptable losses of drilling fluid to the surrounding formation despite the type of drilling fluid employed and filter cake created.

In these instances, fluid-loss control agents may be added to the drilling fluid in an attempt to reduce the unacceptable high losses of drilling fluid to fractures and/or porous structures surrounding the borehole. Known examples of such fluid-loss control agents include graphitic carbon or graphite particles (see e.g. U.S. Pat. No. 5,826,669 (Zakeski) or WO 04/092301 (publication date Oct. 28, 2004)), or water soluble polymeric celluloses, starches or other polysaccharide derivatives. Other fluid-loss control agents have been described including crumb rubber particles (see e.g. U.S. Pat. No. 6,518,224 (Wood)); oil soluble silicone resin particles (see e.g. WO 04/013251 (publication date Feb. 5, 2004)); water insoluble polymer latices (see e.g. U.S. Pat. No. 6,715,568 (Bailey)), particulate polyolefin (see e.g. U.S. Pat. No. 4,436,636 (Carnicom)), polymeric polypropylene granules (see e.g. WO 06/040578 (publication date Apr. 20, 2006). Elastomeric, non-agglomerated acrylate microspheres have been described as efficient fluid loss control additives in WO 2008/156970 (publication date Dec. 24, 2008). Although being effective in controlling fluid loss during a drilling operation, the performance of the microspheres may diminish at increased temperatures, for example, at those temperatures encountered at high drilling frequencies or drilling in deep subterranean formations. Therefore, there is a need for effective fluid loss additives that remain effective also at high temperatures, for example at temperatures such as 150° C. or 175° C.

### SUMMARY

There is an ongoing need for effective additives for drilling fluids which can control (e.g. which can reduce) the loss of the fluids into the materials surrounding the borehole, such as for example, subterranean formations. In light of environmental issues and/or cost factors associated with the use of drilling fluids, in particular oil-based and synthetic-based drilling fluids, it is desirable to provide such an additive that is particularly suitable for controlling fluid loss of such drilling fluids. Furthermore, there is an ongoing need for effective additives for drilling fluids which are thermostable, in particular for additives that sufficiently prevent fluid loss at temperatures exceeding 100° C., such as for example at a temperature of at least 150° C. or even at a temperature of, for example, 175° C.

It has been found that fluoropolymers are effective in reducing fluid loss even at high temperatures. The effectiveness of the fluoropolymers can be further increased if the fluoropolymers are part of polymeric microparticles comprising repeating units derived from one or more acrylate monomers. The fluoropolymers may be incorporated or embedded in the microparticle. Such microparticles may be obtained by polymerising the acrylate monomers in the presence of the fluoropolymer. The fluoropolymers may also be present in the microparticles as copolymers of acrylate monomers, for example by copolymerising polymerisable fluorinated monomers with acrylate monomers. Furthermore, the fluoropolymers may be blended with particles, such as polyacrylate particles.

Therefore, in the following there are provided fluorinated polymeric microparticles comprising one or more repeating units derived from one or more fluorinated monomers and one or more repeating units derived from one or more acrylate monomers.

In another aspect there is provided the use of the microparticles as an additive to a drilling fluid used in a drilling operation to produce a borehole for preventing or reducing loss of the drilling fluid into the material surrounding the borehole.

In a further aspect there is provided the use of fluoropolymers as additives to a drilling fluid used in a drilling operation to produce a borehole for preventing or reducing loss of the drilling fluid into the material surrounding the borehole.

In yet another aspect there is provided a composition comprising the above microparticles and further comprising water, a liquid hydrocarbon having from 10 to 20 carbon atoms, a glycol, a polyglycol, a siloxane and combinations thereof. The composition may be a drilling fluid. Such drilling fluids may be water-based drilling fluids or, in particular, organic-based drilling fluids, such as oil-based drilling fluids and synthetic-based drilling fluids as well as other types of organic-based drilling fluids.

In a further aspect there is provided a process for making fluorinated polymeric microparticles comprising

a) dissolving or dispersing at least one fluoropolymer comprising one or more repeating units derived from a fluorinated monomer into the acrylate monomers or a solution thereof,

b) polymerising the acrylate monomers in the presence of an aqueous phase and a polymerisation initiator.

In another aspect there is provided a process for making fluorinated polymeric microparticles said process comprising:

a) dissolving or dispersing at least one fluorinated monomer that is co-polymerisable with the acryliate monomers into the acrylate monomers or a solution thereof,

b) copolymerising the acrylate and fluorinated monomers in the presence of an aqueous phase and a polymerisation initiator.

In yet another aspect there is provided a method of reducing fluid loss of a drilling fluid into the material surrounding a borehole generated in a drilling operation, said method comprising adding to the drilling fluid the fluorinated polymeric microparticles and circulating said drilling fluid during the drilling of borehole.

In a further aspect there is provided a method of reducing fluid loss of a drilling fluid into the material surrounding a borehole generated in a drilling operation, said method comprising adding to the drilling fluid one or more fluoropolymers and circulating said drilling fluid during the drilling of borehole.

This summary is not intended to describe each disclosed embodiment or every implementation in accordance with the present invention. Dependent claims disclose additional embodiments and many other novel advantages, features, and relationships will become apparent as this description proceeds.

### DETAILED DESCRIPTION

Before any embodiments of this disclosure are explained in detail, it is to be understood that the disclosure is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. Contrary to the use of “consisting”, the use of “including,” “containing”, “comprising,” or “having” and variations thereof is meant to encompass the items listed thereafter and equivalents thereof as well as additional items. The use of “a” or “an” is meant to encompass “one or more”. Any numerical range recited herein is intended to include all values from the lower value to the upper value of that range. For example, a concentration range of from 1% to 50% is intended to be an abbreviation and to expressly disclose the values between the 1% and 50%, such as, for example, 2%, 40%, 10%, 30%, 1.5%, 3.9% and so forth.

It has been found that fluoropolymers when used as additives to drilling fluids can reduce loss of the drilling liquid in drilling operations. Such additives have been found to be thermostable, which means the additives remained effective in reducing fluid loss even at high temperatures, such as for example at 150° C. or even at 175° C.

The fluorpolymers may be in particulate form (i.e., they may be fluoropolymer particles or particles comprising fluoropolymers). The particles may have the shape and dimension as described below for the “fluorinated polymeric microparticles”. Suitable fluoropolymers include those described below in the section titled “fluoropolymers”. Typically, the fluoropolymers comprise repeating units derived from at least one fluorinated monomer, such as those described below.

Additives may also be prepared by blending fluoropolymers with other particles, for example, but not limited to, the acrylate-based microspheres described in WO 2008/156970.

The effectiveness of fluoropolymers as thermostable fluid loss control agents may be further increased if the fluoropolymers are part of microparticles that contain repeating units derived from one or more acrylate monomers. Such microparticles are referred to in the following as “fluorinated polymeric microparticles”. Such microparticles may provide additives that may be effective as fluid loss control agent and may remain effective also at increased temperatures such as, for example, about 125° C., about 150° C. or even about 175° C. may be obtained. The fluorinated polymeric microparticles may comprise one or more polymer comprising one or more repeating units derived from one or more acrylate monomer and may additionally also contain one or more fluoropolymers. The fluoropolymers may, for example, be incorporated or embedded in the “polyacrylate” microparticle. Such fluorinated polymeric microparticles may be obtained, for example, by polymerising acrylate monomers in the presence of a fluoropolymer, preferably in the presence of an aqueous phase containing a polymerisation initiator and which may further contain one or more emulsifiers and cross-linking agent capable of cross-linking acrylate monomers and/or the fluoropolymer with the acrylate monomers.

The fluoropolymers may also be present in the fluorinated polymeric microparticles as copolymers, for example, as “fluoroacrylate copolymers”, i.e. copolymers of fluorinated monomers and acrylate monomers and optionally further comonomers. Such fluorinated polymeric microparticles may be obtained, for example, by copolymerising acrylate monomer with fluorinated monomers that are copolymerisable with the acrylate monomers (and optionally other copolymerisable monomers). Preferably, the polymerisation is carried out by emulsion polymerisation in the presence of an aqueous phase containing a polymerisation initiator and which may further contain one or more emulsifiers and cross-linking agent capable of cross-linking acrylate monomers and/or the fluorinated monomers with the acrylate monomers.

In both of the above described embodiments fluorinated polymeric microparticles are obtained that comprise one or more repeating units derived from one or more fluorinated monomers and one or more repeating units derived from one or more acrylate monomers. Fluorinated monomers, acrylate monomers, fluorinated polymeric microparticles, their composition, preparation and use as drilling fluid additives will be illustrated in greater detail the following.

Fluorinated Polymeric Microparticles

The fluorinated polymeric microparticles typically have a diameter (or a longest dimension) of from about 0.1 to about 100 microns. The microparticles may be spherical or substantially spherical, in which case they may be also referred to as microspheres. Substantially spherical particles have an x-, y- and z-axis which are perpendicular to each other. In case of a perfect sphere these x-, y- and z axes would be of essentially equal length. Substantially spherical particles have a morphology that is more similar to a sphere than to a platelet-shaped or a square particle. Typically, the x-, y- and z-axes of a substantially spherical particle are not of equal length. Typically, the longest of these axes may be up to 50% longer than the smallest axis.

The microparticles may have a mean diameter (or longest dimension, respectively) of up to about 100 microns. Mean diameter as referred to herein represents the number average.

At least 50% by volume of the microparticles may have a diameter up to about 100 microns, more desirable at least 70% by volume of the microparticles have a diameter (or longest dimension) of up to about 100 microns, and most desirable at least 90% by volume of the microparticles have a diameter of up to about 100 microns. Typically, the microparticles have a diameter of at least about 0.1 micron, more desirably at least about 0.3 micron, even more desirably at least about 0.5 micron, most desirably greater than about 1 micron. Typically, the microparticles have a diameter of from about 0.1 micron to up to about 100 microns, or from about 0.3 microns to up to about 100 microns or from about 0.5 microns to up to about 100 microns. Particle sizes can be determined, for example, by light scattering methods or microscopy as known in the art.

For use as additives in fluid loss control, it is generally desirable to use microparticles having a mean diameter equal to or less than 90 microns; more desirably a mean diameter equal to or less than 70 microns; and most desirably a mean diameter equal to or less than 50 microns.

The microparticles may have at least one glass transition temperature (Tg) equal to or above about −80° C., more suitably between about −75° C. and about 125° C. For use as a fluid additive it is desirable to use microparticles having a glass transition temperature that is below the borehole temperature, for example up to about 10 ° C. or up to about 30° C. below the borehole temperature.

The microparticles are favourably insoluble in water, which means that less than 1% wt of the microparticles dissolve in water at ambient conditions (25° C., 1 bar). This can be measured, for example, by adding 10 g of microparticles (that had been dried in an oven at 100° C. for three hours) to 100 ml distilled water in a 200 ml measuring cylinder and stirring for one hour at ambient conditions (25° C., 1 bar). Then the undissolved microparticles are filtered off and dried in an oven at 100° C. for three hours. The aqueous filtrate is removed by distillation and the residue is dried and weighed for solid content.

The microparticles are favourably insoluble in organic liquid, such as diesel, kerosene, and specifically in liquid hydrocarbons containing from 10 to 20 carbon atoms, mixtures of liquid hydrocarbons containing from 10 to 20 carbon atoms. This means that no, or less than 1% wt of the microparticles dissolve in the liquid at ambient conditions. This can be measured in an analogue way as described above for water (the microparticles are dried by evaporation of the organic liquid for three hours under vacuum under conditions where the organic liquid boils).

The microparticles are also favorably readily dispersible in water and/or an organic solvent (eg kerosene, diesel), a liquid hydrocarbon containing 10 to 20 carbon atoms or oils (such as mineral oils, synthetic oils etc).

The microparticles may be provided in a dry form (e.g. microparticles provided in the form of a dry powder), or in the form of a dispersion in an organic liquid, such as for example, a liquid hydrocarbon containing from 10 to 20 carbon atoms, or in water.

The microparticles favourably do not swell or only poorly swell when added to water or liquid hydrocarbons comprising 10 to 20 carbon atoms. This can be achieved by using cross-linkers in the preparation of the microparticles, i.e. the microparticles are cross-linked. Typically, the greater the degree of cross-linking the lower the swell volume of the particles. Generally it may be desirable, in particular when used as a fluid control additive that the microparticles have a volume swell factor at 25° C. of at most 4, more favorable at most 3, even more favourable at most 2 in an organic liquid, such as kerosene or diesel, in particular a liquid hydrocarbon having from about 10 to about 20 carbon atoms or a mixture of liquid hydrocarbons having from about 10 to about 20 carbon atoms. The volume swell factor represents the factor increase in volume upon swelling. For example, if the volume taken up by the microparticles doubles, the volume swell factor is 2, if the volume triples, the volume swell factor is 3, if the volume quadruples, the swell factor is 4. The swell volume can be measured as described in the method section.

The microparticles may be hollow or solid particles. The microparticles are generally, favourably thermostable. The microparticles are resistant to temperatures of at least 150° C., or at least 175° C. This means they do not decompose at a temperature below 150° C. (or 175° C., respectively). However, it is acceptable, that the microparticles lose weight upon heating to 150° C. or 175° C. which may be due to the evaporation of monomers or oligomers that may be bound to the particles. A weight loss of up to 10% wt based on the weight of the dried microparticles before subjecting the microparticles to a temperature of for example 150° C., or 175° C. respectively, is acceptable and is not regarded as a decomposition of the microparticle.

The fluorinated polymeric microparticles comprise one or more repeating unit derived from one or more acrylate monomers and one or more repeating unit derived from a fluorinated monomer. The repeating units derived from a fluorinated monomer may be part of a fluoropolymer. This means the fluorinated monomers (or oligomers thereof) have not been copolymerized with the acrylate monomers. In such embodiments the microparticles comprise at least one fluoropolymer and a polymer comprising one or more repeating units derived from one or more acrylate monomers, such as for example an acrylate polymer, like a polyacrylate or a polyacrylate comonomer. The repeating units derived from a fluorinated monomer may, however, also be part of a “fluoroacrylate” copolymer, i.e. a copolymer of fluorinated monomers and acrylate monomers. The fluorinated polymeric microparticles may further comprise repeating units derived from non-fluorinated monomers that are copolymerisable with the acrylate monomers.

The fluorinated polymeric micropartices may be cross-linked, for example by cross-linker capable of cross-linking acrylate monomers and/or capable of cross-linking acrylate monomers with fluorinated or non fluorinated monomers that are copolymerisable with the acrylate monomers.

Acrylate Monomers:

Acrylate monomers suitable for making the microparticles such that the microparticles comprise one or more repeating units derived from one or more acrylate monomers include ethylenically unsaturated esters.

The ethylenically unsaturated esters are preferably monofunctional with respect to the unsaturation, (i.e. only contain one ethylenic unsaturation. The unsaturation is polymerisable, preferably polymerisable by a radical polymerisation). Acrylate monomers include, for example, but not limited to, acrylic acid ester and methacrylic acid ester. Typically, the acrylate monomers are alkyl acrylate ester or alkyl methacrylate ester.

Useful acrylate monomers include monofunctional unsaturated alkyl acrylate esters and alkyl methacrylate esters, in particular ester of acrylic acid or methacrylic acid and non-tertiary alkyl alcohols and mixtures thereof. Typically, the alkyl groups of the alkyl ester have from 4 to 20 or from 4 to 14 carbon atoms. Such monomers are oleophilic, water emulsifiable and have restricted water solubility. Included within this class of monomers are, for example, acrylate monomers selected from the group consisting of isooctyl acrylate, 4-methyl-2-pentyl acrylate, 2-methylbutyl acrylate, isoamyl acrylate, sec-butyl acrylate, n-butyl acrylate, ethylhexyl acrylate, isodecyl methacrylate, isononyl acrylate, isodecyl acrylate, isobornyl acrylate and mixtures thereof. Preferred acrylate monomers include those selected from the group consisting of isooctyl acrylate, isononyl acrylate, isoamyl acrylate, isodecyl acrylate, ethylhexyl acrylate, n-butyl acrylate, sec-butyl acrylate, isobornyl acrylate and mixtures thereof.

Other free radically polymerisable monofunctional ethylenically unsaturated esters such as, but not limited to, tert-butyl acrylate, isobornyl acrylate, and vinyl acetates, may be utilized in conjunction with one or more of the alkyl acrylate esters or alkyl methacrylate esters described above.

Non-Fluorinated Monomers that are Copolymerisable with Acrylate Monomers:

The fluorinated polymeric microparticles may further comprise one or more repeating unit derived from a non-fluorinated monomer that is copolymerisable with the one or more acrylate monomers.

Such non-fluorinated monomers include polar and non polar monomers which are copolymerisable with the acrylate monomers. Examples of suitable polar co-monomers include both strongly polar and moderately polar monomers, and mixtures thereof. Examples of strongly polar monomers include ethylenically unsaturated monocarboxylic and dicarboxylic acids and salts thereof.

Examples of such monomers include acrylic acid, beta-carboxy ethyl acrylate and the salts thereof, such as sodium acrylate and ammonium acrylate; methacrylic acid and salts thereof, such as sodium methacrylate and ammonium methacrylate, itaconic acid, fumaric acid, crotonic acid and maleic acid and salts thereof. Further examples of strongly polar monomers include derivatives of ethylenically unsaturated monocarboxylic and dicarboxylic acids and salts thereof as well as derivatives of ethylenically unsaturated monosulfonic acids and salts thereof. Examples include acrylamides and methacrylamides, substituted acrylamides, in particular acid substituted acrylamides and salts thereof (such as 2-acrylamido-2-methyl-1-propanesulfonic acid and salts thereof such as its sodium or potassium salt), substituted methacrylamides, in particular acid substituted methacrylamides and salts thereof, dimethyl amino-propyl methacrylate and 2-hydroxyalkyl acrylates, such as 2-hydroxyethyl acrylate. Examples of moderately polar co-monomers include polar vinyl monomers, such as N-vinyl pyrrolidone, N-vinyl caprolactam, acrylonitrile, vinylchloride, vinylidenechloride and mixtures thereof. Other useful polar co-monomers include ionic monomers which are copolymerizable with alkyl acrylate ester or alkyl methacrylate ester monomer(s). Useful ionic monomers include ionic derivatives of ethylenically unsaturated monocarboxylic and dicarboxylic acids (e.g. ionic derivatives of acrylates or methacrylates). Examples include N,N-dimethyl-N-([beta]-methacryloxyethyl) ammonium propionate betaine, trimethylamine methacrylimide and 1,1-dimethyl-1-(2,3-dihydroxypropyl) amine methacrylimide. Further useful ionic monomers include ionic vinyl monomers, such as trimethylamine p-vinyl benzimide and sodium styrene sulphonate. Still further useful polar co-monomers include acrylate-, methacrylate-, vinyl-terminated poly(alkylene oxides) (such as acrylate-terminated poly(ethylene oxide); acrylate-, methacrylate-, vinyl-terminated poly(vinyl methyl ethers); acrylate-, methacrylate-, vinyl-terminated poly(acrylamides); acrylate-, methacrylate-, vinyl-terminated poly(n-vinylpyrrolidones); acrylate-, methacrylate-, vinyl-terminated poly(vinyl alcohols); and mixtures thereof. Preferred polar co-monomers include those selected from the group consisting of acrylic acid, beta-carboxy ethyl acrylate, ammonium acrylate, acrylonitrile, N-vinylpyrrolidone, sodium styrene sulphonate, acrylate-terminated poly(ethylene oxide) and mixtures thereof

Examples of non-polar comonomers include vinylic hydrocarbons, such as for example, but not limited to, styrene.

Fluorinated Monomers that are Copolymerisable with Acrylate Monomers:

Instead of one or more fluoropolymers or in addition thereto, the fluorinated polymeric microparticles may also comprise one or more repeating unit derivable from a fluorinated monomer that is copolymerisable with the acrylate monomers.

Examples of such fluorinated monomers include those represented by the general formula (I)

R_{f}-Q-C(R′₁)═C(R′₂)(R′₃) (I)

wherein R_{f} represents a fluorinated aliphatic group, preferably a fluorinate aliphatic group having 3 to 12 carbon atoms, Q is an organic linking group; R′₁ represents hydrogen, halogen or a lower alkyl group having 1 to 4 carbon atoms and each R′₂ and R′₃ are independently hydrogen or a straight chain or branched chain alkyl, preferably an alkyl chain of 1 to 4 carbon atoms.

The fluorinated aliphatic group R_{f}, in the fluorinated monomer, may be a partially or fully fluorinated, preferably saturated, non-polar, monovalent aliphatic radical. It can be straight chain, branched chain, or cyclic or combinations thereof. It can contain heteroatoms such as oxygen, divalent or hexavalent sulfur, or nitrogen. R_{f} is preferably a fully-fluorinated radical, but hydrogen or chlorine atoms can be present as substituents if not more than one atom of either is present for every two carbon atoms. The R_{f} radical has at least 3 carbon atoms, typically at least 3 and up to 12 carbon atoms, suitably 3 to 10, especially suitable 4 to 6 carbon atoms.

The linking group Q links the fluoroaliphatic group R_{f} to the ethylenically unsaturated group and is generally a non-fluorinated organic linking group. The linking group Q may be a hydrocarbon group which may optionally be substituted and which generally contains from 1 to about 20 carbon atoms. Linking group Q may optionally contain oxygen, nitrogen, or sulfur-containing groups or a combination thereof, but Q should typically be free of functional groups that substantially interfere with free-radical polymerization (e.g., polymerizable olefinic double bonds, thiols, and other such functionality known to those skilled in the art).

Examples of suitable linking groups Q include straight chain, branched chain or cyclic alkylene, arylene or aralkylene groups, sulfonyl, sulfoxy, sulfonamido, carbonamido, carbonyloxy, urethanylene, ureylene, oxy, and combinations thereof such as sulfonamidoalkylene.

Preferably, Q is a carbonyloxy moiety and the fluorinated monomers are represented by the general formula R_{f}—OCO—C(R′₁)═C(R′₂)(R′₃).

Examples of useful fluorinated monomers include:

CF₃CF₂CF₂CF₂CH₂CH₂OCOCR₃═CH₂

CF₃(CF₂)₃CH₂OCOCR₃═CH₂

CF₃(CF₂)₃SO₂N(CH₃)CH₂CH₂OCOCR₃═CH₂

CF₃(CF₂)₃SO₂N(C₂H₅)CH₂CH₂OCOCR₃═CH₂

CF₃(CF₂)₃SO₂N(CH₃)CH₂CH(CH₃)OCOCR₃═CH₂

(CF₃)₂CFCF₂SO₂N(CH₃)CH₂CH₂OCOCR₃═CH₂

CF₃CF₂(CF₂CF₂)₂CH₂CH₂OCOCH═CH₂

wherein R₃ is hydrogen, methyl, ethyl, propyl or n-butyl.

Cross-Linker:

The fluorinated polymeric microparticles are favourably cross-linked. Typically, the microparticles are cross-linked by multifunctional crosslinking agent(s). The term “multifunctional” as used herein refers to crosslinking agents which possess at least two (more particularly at least three) free radically polymerizable ethylenically unsaturated groups. When used, crosslinking agent(s) is (are) favourably used at a level of up to about 10 equivalent weight %, more favourably from about 0.3 to about 7 equivalent weight % of the total polymerisable composition. Useful multifunctional crosslinking agents include those selected from the group consisting of acrylic or methacrylic esters of diols such as butanediol, triols such as glycerol, and tetrafunctional alcohols such as pentaerythritol. Other useful crosslinking agents include those selected from the group consisting of other multifunctional vinyl compounds and multifunctional acrylated oligomers. Preferred crosslinking agents include those selected from the group consisting of multifunctional (meth)acrylates (e.g., 1,4-butanediol diacrylate or 1,6-hexanediol diacrylate); polyvinylic crosslinking agents, such as substituted and unsubstituted divinylbenzene; and difunctional urethane acrylates, such as those available under the trade designation EBECRYL. 270 and EBECRYL. 230 (1500 weight average molecular weight and 5000 weight average molecular weight acrylated polyurethanes, respectively, both available from Cytec Specialty Chemicals, Anderlecht, Belgium).

Fluoropolymers:

In addition to the above, or instead of fluorinated monomers that are copolymerisable with acrylate monomers, the microparticles may also contain fluoropolymers. The fluoropolymers may be cross-linked with the acrylate-polymers or they may not be cross-linked with the acrylate-polymers.

Fluoropolymers are fluorine-containing polymers. Fluoropolymers comprise one or more repeating units derived from one or more fluorinated monomers. Fluorinated monomers, typically fluorine-containing olefins, include those of the general formula (II)

X₂C═CXZ (II)

wherein each X may be the same or different and is selected from the group consisting of hydrogen, F and Cl, with the proviso that at least one X represents F, Z represents hydrogen, F, Cl, Br, I, a fluorinated or perfluorinated alkyl group, a fluorinated or perfluorinated alkoxy group or a (per)fluoropolyether group. Examples of (per)fluoroalkyl groups include linear or branched (per)fluoroalkyl groups having between 1 and 8 carbon atoms, for example 1 to 5 carbon atoms. Examples of (per)fluoroalkoxy groups include those that have between 1 and 8 carbon atoms, for example between 1 and 5 carbon atoms, in the alkyl group, and whereby the alkyl group may be linear or branched. Examples include perfluoropolyether groups, such as those corresponding to the formula:

—O(R¹_{f}O)ₙ (R²_{f}O)ₘR³_{f}

wherein R¹_{f} and R²_{f} are each linear or branched perfluoroalkylene groups of 1 to 6 carbon atoms, in particular 2 to 6 carbon atoms; m and n are independently 0 to 10 with m+n being at least 1; and R³_{f} is a perfluoroalkyl group of 1 to 6 carbon atoms. The term “perfluorinated” means all hydrocarbon atoms of a hydrocarbon residue have been replaced by fluorine atoms. For example, CF₃— is a perfluoromethyl group. When a group is referred to as “(per)fluoro-” the group may be fluorinated (i.e. it may still contain hydrogen atoms) or it may be perfluorinated.

In a particular embodiment, olefins of formula (II) can be employed wherein X is F and Z is a (per)fluoroalkyl group or a (per)fluoroalkoxy group or a (per)fluoropolyoxyalkyl group.

Specific examples of olefins according to formula (II) include but are not limited to include tetrafluoroethylene, chlorotrifluoroethylene, vinylidene fluoride, vinylidene chloride, vinyl chloride, perfluoroalkyl vinyl monomers such as hexafluoropropylene, fluorinated or perfluorinated allyl ethers, fluorinated or perfluorinated vinyl ethers.

Examples of perfluorovinyl or perfluoroallyl ethers include those that correspond to the formulae:

CF₂═CF—O—R_{f} and CF₂═CF—CF₂—O—R_{f}

wherein R_{f} represents a perfluorinated aliphatic group that may contain one or more oxygen atoms or that may contain no oxygen atom. Particular examples of perfluorinated vinyl ethers correspond to the formula:

CF₂═CF—(CF₂)ₐ—O(R^{a}_{f}O)ₙ (R^{b}_{f}O)ₘR^{c}_{f}

wherein R^{a}_{f} and R^{b}_{f} are different linear or branched perfluoroalkylene groups of 1 to 6 carbon atoms, in particular 2 to 6 carbon atoms, m and n are independently 0 to 10 and R^{c}_{f} is a perfluoroalkyl group of 1 to 6 carbon atoms, a represents 1 (in case of allylethers) or 0 (in case of vinylethers).

Specific examples of perfluorinated vinyl ethers include perfluoro methyl vinyl ether (PMVE), perfluoro n-propyl vinyl ether (PPVE-1), perfluoro-2-propoxypropylvinyl ether (PPVE-2), perfluoro-3-methoxy-n-propylvinyl ether, perfluoro-2-methoxy-ethylvinyl ether and CF₃—(CF₂)₂—O—CF(CF₃)—CF₂—O—CF(CF₃)—CF₂—O—CF═CF₂, and the corresponding allyl ethers.

The fluoropolymers may be homo- or copolymers. Typically, the fluoropolymers are copolymers, wherein the comonomers may also be fluorinated. Suitable comonomers also include non-halogenated olefins such as, for example, ethylene and propylene.

Specific examples of fluoropolymers include but are not limited to copolymers of tetrafluoroethylene and hexafluoropropylene, copolymers of tetrafluoroethylene and perfluorovinyl ether (for example perfluoromethylvinyl ether, perfluoropropylvinylether or combinations thereof), copolymers of vinylidene fluoride and hexafluoropropylene, copolymers of tetrafluoroethylene and vinylidene fluoride, copolymers of chlorotrifluoroethylene and vinylidene fluoride, copolymers of tetrafluoroethylene and ethylene, copolymers of tetrafluoroethylene and propylene, copolymers of vinylidene fluoride and perfluorovinyl ether (for example PMVE or PPVE) terpolymers of tetrafluoroethylene, hexafluoropropylene and perfluorovinyl ether (for example PMVE, PPVE or a combination thereof), terpolymers of tetrafluoroethylene, ethylene or propylene and perfluorovinyl ether (for example PMVE, PPVE or a combination thereof), terpolymers of tetrafluoroethylene, ethylene or propylene and hexafluoropropylene, terpolymers of tetrafluoroethylene, vinylidene fluoride and hexafluoropropylene, terpolymers of vinylidene fluoride, tetrafluoroethylene and perfluorovinyl ether (for example PMVE, PPVE or a combination thereof), copolymers of tetrafluoroethylene, ethylene or propylene, hexafluoropropylene and perfluorovinyl ether (for example PMVE, PPVE or a combination thereof).

In one embodiment the fluoropolymers used in the preparation of microparticles are curable fluoropolymers. Curable fluoropolymers may contain groups that are reactive to a curing reagent, for example a peroxide. Such groups include for example iodine or bromine atoms which may be incorporated into the fluoropolymer by using Br- or I-containing chain transfer agents during the preparation of the fluoropolymers or by using in the preparation of the fluoropolymer so-called cure site monomers, which are typically bromine and/or iodine containing olefins.

The fluoropolymers may be perfluorinated or partially fluorinated. The fluoropolymers may be crystalline or amorphous. Amorphous polymers do not have a distinct melting point, i.e. a melting point over a range of less than 3° C. Instead they may have no melting point at all or a melting range, instead of a melting point, wherein the melting range covers at least 4 or even at least 10° C., e.g. a melting range of from about 230 to about 240° C.

The fluoropolymers are preferably soluble in the acrylate monomers used to make the microparticles. However, it is also possible to disperse the fluoropolymers in the liquid acrylate monomers or a solution thereof. In that case it is favourable to disperse the fluoropolymers as small enough particles such that the microparticles can be generated around them when polymerising the acrylate monomers.

Preferably, the fluoropolymers have a melting point or melting range as may it be the case, exceeding the temperature encountered in the drilling operation. Typically, the polymers have a melting point of at least 125° C., preferably of at least 150° C. and more preferably at least 175° C.

Preferably, the fluoropolymers are elastomers, i.e. they have elastomeric properties or become elastomeric upon curing. Elastomeric polymers can be elongated by application of force to at least 10% of their original length and retain their original length when that force is no longer applied.

As already described above, the fluoropolymers may also be used as a drilling fluid additves as such, which means without being part of the fluorinated polymeric particles. The fluoropolymers may be used as additives also as blends with fluorinated polymeric microparticles or as blend with non-fluorinated microparticles or other particles. Suitable fluoropolymers include those described above. The fluoropolymers may be used in dry form, e.g. as a powder or used as a dispersion, for example a dispersion in water or in an organic liquid.

Preparation of Fluorinated Polymeric Microparticles:

The fluorinated polymeric microparticles may be prepared by aqueous suspension polymerization techniques. In general terms, the microparticles may be prepared using an emulsification process. In the emulsification process monomer droplets are formed in an aqueous phase, followed by polymerisation of the monomer droplets to form microparticles. The polymerisation is typically carried out in the presence of a polymerisation initiator, which typically is a radical polymerisation initiator. The radical polymerisation initiator decomposes (thermally, chemically or by irradiation) to release radicals. The polymerisation is also typically carried out in the presence of one or more emulsifiers. Comonomers and/or cross-linker may also be present.

The emulsion of monomer droplets is typically formed by blending a variety of components in one or more steps. The components typically include monomer(s), initiator,—fluoropolymer(s) if applicable—and optional cross-linking agents, and water. Other components which may be used include stabilizers and thickening agents. The emulsion is preferably formed by agitating the mixture of components using, for example, mechanical or ultrasonic means.

The microparticles formed by this method are typically spherical or substantially spherical.

The particle size of the microparticles depends on the droplet size of the organic phase in the emulsion which is influenced by the concentration of the organic phase and the stirring speed or ultrasound frequency or energy used. Typically, particle sizes (diameter or longest dimension) of from about 0.1 to about 100 microns may be obtained.

Hollow microparticles can be made via a “two-step” or a “one-step” emulsification process for example, as described, in U.S. Pat. No. 5,053,436 (Delgado). In the first step of the two-step process, a water-in-oil emulsion is formed by combining an aqueous solution of monomers that are copolymerisable with acrylate monomers (co-monomers) with a mixture of at least one acrylate monomer, (optionally one or more fluoropolymer(s)), an initiator and, if applicable, a cross-linking agent in the presence of an emulsifier having a low hydrophilic-lipophilic balance (HLB) value. A thickening agent, (e.g., methyl cellulose) may be included in the aqueous phase prior to formation of the water-in-oil emulsion. Where it is desirable not to include a co-monomer, water may be mixed directly with at least one acrylate monomer, initiator and cross-linking agent, and emulsifier to form the water-in-oil emulsion. Suitable emulsifiers are those having an HLB value below about 7, preferably in the range of about 2 to about 7. Emulsifiers having an HLB value of greater than about 7 tend to produce an oil-in-water emulsion as opposed to the desired water-in-oil emulsion. Examples of emulsifiers having HLB values less than 7 include sorbitan monoleate, sorbitan trioleaste, and ethoxylated oleyl alcohol for example available under the trade designation BRIJ 93, available from Sigma-Aldrich, Bornem, Belgium. In the second step, a water-in-oil-in-water emulsion is formed by dispersing the water-in-oil emulsion from the first step into an aqueous phase containing an emulsifier having an HLB value above about 6 and, if applicable, any portion of the co-monomers not added in step one. Examples of suitable emulsifiers for the second step include ethoxylated sorbitan monooleate, ethoxylated lauryl alcohol, and alkyl sulfates. In both steps, the concentration of the emulsifier should be greater than its critical micelle concentration.

In a “one step” emulsification process as is described in U.S. Pat. No. 5,053,436 (Delgado), at least one acrylate monomer and at least one monomer that is polymerisable with the acrylate monomer (and/or a fluoropolymer if applicable), initiator and, if applicable, a cross-linking agent are mixed in the presence of at least one emulsifier capable of producing a water-in-oil emulsion which is substantially stable during emulsification and polymerization.

As in the two-step emulsification process, the emulsifier is preferably utilized in concentrations greater than its critical micelle concentration. In general, high HLB emulsifiers are required, i.e., emulsifiers having an HLB value of at least about 25, to produce stable cavity-containing droplets during the polymerization. Examples of such emulsifiers include alkylarylether sulfates such as sodium alkylarylether sulfate (e.g., available under the trade designation TRITON W-30 from Dow, Horgen, Switzerland) and alkylarylpoly ether sulfates such as alkylarylpoly(ethylene oxide) sulfates. Alkyl sulfates, alkyl ether sulfates, and alkylarylether sulfates are preferred as they provide a maximum void volume per microsphere for a minimum amount of surfactant. Polymeric stabilizers may also be present but are not necessary. Solid microparticles useful in the present invention, may be prepared via an emulsion process and method described, for example, in U.S. Pat. No. 3,691,140 (Silver). This process comprises aqueous suspension polymerization of at least one acrylate monomer with at least one (fluorinated or non-fluorinated) monomer that copolymerisable with the acrylate monomer in the presence of an initiator and, if applicable, a cross-linking agent and, if applicable a fluoropolymer, and an anionic emulsifier in a concentration greater than its critical micelle concentration. Non-ionic emulsifiers may be included so long as an anionic emulsifier is present and predominates. Examples of emulsifiers include: alkylarylether sulfates; alkylarylpolyether sulfates such as ammonium lauryl sulfate, triethanolamine lauryl sulfate and triethanolamine lauryl sulfate and sodium hexadecyl sulfate; alkyl ether sulfates such as ammonium lauryl ether sulfates; and alkylpolyether sulfates such as alkyl poly(ethylene oxide) sulfates.

The amount of emulsifier used in the aforesaid emulsion processes in suspension polymerization to form the polymeric microparticles is such that it is greater than its critical micelle concentration. The critical micelle concentration is defined as the minimum concentration of emulsifier necessary for the formation of micelles. Critical micelle concentration is typically slightly different for each emulsifier. Useful concentrations typically range from about 1.0×10⁻⁴ to about 3.0 moles/liter.

An initiator is typically used for the polymerization of the monomer droplets. Useful initiators include those which are normally suitable for free radical polymerization of acrylate monomers. Preferred initiators include those which are oil-soluble. Examples of such initiators include thermally-activated initiators such as azo compounds (for example, but not limited to 2,2′-azobis(2,4-dimethyl)valeronitrile), hydroperoxides, peroxides (for example, but not limited to benzoylperoxide), and the like, and photoinitiators such as benzophenone, benzoin ethyl ether, and 2,2-dimethoxy-2-phenyl acetophenone. The initiator is generally present in an amount ranging from about 0.01 to about 10 weight percent of the total weight of the polymerisable composition. Once the appropriate emulsion is prepared, polymerization is initiated by application of radiation or heat, for example by heating up to about 60° C. Following polymerization by any of the useful aqueous suspension polymerization processes, an aqueous suspension of microparticles is obtained. The size of the resulting microparticles can generally be tailored through an appropriate selection of the emulsifier, concentration thereof and/or an appropriate selection of agitation during the preparation. The suspension may have non-volatile solid contents of from about 10 to about 50 percent by weight and may be used “as is” as an additive for a drilling fluid to control fluid loss. Alternatively the resulting aqueous suspension may be allowed to stand and separate into two phases, one phase being aqueous and substantially free of polymer, the other phase being an aqueous suspension of microparticles, followed by decantation of the microparticle-rich phase to provide an aqueous suspension having a non-volatile solids content on the order of about 40 to about 70 percent which then may be used as an additive for a drilling fluid to control fluid loss. Alternatively, for example, if desired, the aqueous phase can be removed to provide the microparticles in dried form. For example, the aqueous phase can be precipitated with an alcohol solvent, the precipitate collected and washed to obtain microparticles in dried form. Such obtained microparticles are typically substantially free of surfactant (e.g. at most 1% by weight of surfactant relative to total weight of microparticles). Or alternatively, for example, again as desired, the microparticles can be suspended in a solvent (such as ethylacetate, tetrahydrofuran, heptane, 2-butanone, benzene, toluene, cyclohexane, C₁₀-C₂₀ hydrocarbon, or mixtures thereof) or in an oil (such as diesel oil, biodiesel oil, mineral oil, or mixtures thereof).

The fluorinated microparticles can be described as comprising a polymerization product of (a) one or more alkyl acrylate ester or alkyl methacrylate ester and either (b) one or more co-monomer or (c) a cross-linking agent or both (b) and (c) (i.e. both a co-monomer and a cross-linking agent). In some embodiment the reaction product also comprises (d) one or more fluoropolymer. The fluoropolymer may not react by forming new chemical bonds but may just be incorporated or embedded in the microparticles formed by the polymerisation or it may also form chemical bonds with the monomers and/or cross-linkers used to prepare the microparticles.

The amount of fluoropolymer present in the microparticle may be primarily determined by its solubility on the monomer solution. Typically, the microparticles comprise from about 0.5% to about 30% wt or from about 2% to about 20% wt based on the total weight of the microparticles of fluoropolymers.

Typically, the microparticles comprise a polymerization product comprising: (a) about 80 to about 99.7 equivalent weight % of at least one alkyl acrylate ester or alkyl methacrylate ester and (b) one or more co-monomers up to about 20 equivalent weight % and/or (c) a multifunctional cross-linking agent up to about 10 equivalent weight %. Moreover acrylates may favourable comprise a polymerization product comprising: about 90 to about 99.7 equivalent weight % of at least one alkyl acrylate ester or alkyl methacrylate ester, and about 0.3 to about 10 equivalent weight % of a multifunctional cross-linking agent. Acrylates may favourable comprise a polymerization product comprising: about 80 to about 99.7 equivalent weight % of at least one alkyl acrylate ester or alkyl methacrylate ester and about 0.3 to about 20 equivalent weight % of a co-monomer and (c) 0 to up to about 10 equivalent weight % of a multifunctional cross-linking agent. The co-monomers may be fluorinated or non-fluorinated. The co-monomers are copolymerisable with the acrylate monomers.

Polymerization products including a polar co-monomer are more favourable, and such polymerization products including both a polar co-monomer and a multifunctional cross-linking agent are most favourable.

The fluorinated polymeric microparticles are generally, desirably infusible, solvent-dispersible, solvent-insoluble and water-insoluble.

The glass transition temperature of the resulting micropaticles can be suitably adjusted through appropriate selection of the alkyl (meth)acrylate ester. Also, as applicable, the selection of the appropriate amount of cross-linking agent and/or the appropriate selection of co-monomers can allow for adjustment of the glass transition temperature. For example, in general the higher the homopolymer glass transition temperature of an alkyl (meth)acrylate ester the higher the glass transition temperature of the resulting microparticles. Increasing the amount of cross-linking agent will generally increase the glass transition temperature of the resulting microparticles. Also the particular nature of a co-monomer can affect the glass transition temperature of the resulting microparticles, for example the use of 2-acrylamido-2-methyl-1-propanesulfonic acid versus acrylic acid as a polar co-monomer generally increases the glass transition temperature of the resulting microparticles.

Additives:

An additional aspect of the present invention is the provision of a drilling fluid comprising fluoropolymers or fluorinated polymeric microparticles as described herein. Such drilling fluids may be water-based drilling fluids or, in particular, organic-based drilling fluids, such as oil-based drilling fluids and synthetic-based drilling fluids as well as other types of organic-based drilling fluids.

The use of such microparticles or fluoropolymers as a fluid loss control additive in drilling fluids is advantageously effective in reducing fluid loss of drilling fluids into or through subterranean formation (e.g. porous formations) or formations having pre-existing or drill-induced fissures or fractures, surrounding the borehole.

Furthermore, use of the microparticles and/or fluoropolymers described herein is particularly desirable in that the addition of such an additive to a drilling fluid typically does not have any appreciable impact on the rheological properties of the drilling fluid. This holds particularly true for organic-based drilling fluids, such as oil-based and synthetic-based drilling fluids as well as other types of organic-based drilling fluids.

In most instances the microparticles or fluoropolymers described herein can be used as fluid loss control additives without the need of having to add other additives to re-adjust rheological properties of the drilling fluid. They can be easily and effectively used as a “prophylactic” to control loss of drilling fluid during drilling operations or as a “pill” treatment, when during drilling operations unacceptable levels of fluid loss are observed.

The microparticles and fluoropolymers described herein or compositions containing them can be used as additives to the drilling fluid at very high concentrations (e.g. up to 300 kg/m³ relative to weight of microparticles), if desired. Generally however the concentration of additive, in other words microparticles and/or fluoropolymers, in the drilling fluid is selected for the particular drilling operation so that the concentration of microparticles and/or fluoropolymers in the drilling fluid is sufficient to reduce fluid loss. It has been found that additives described herein have such advantageous effectiveness in controlling fluid loss, generally the concentration of microparticles and/or fluoropolymers in drilling fluid need not be high. This holds particularly true for organic-based drilling fluids, such as oil-based drilling fluids and synthetic-based drillings fluids as well as other types of organic-based drilling fluids. Favourably the concentration of microparticles and/or fluoropolymers in drilling fluid may be 10 w/w % or lower, more favorably 8 w/w % or lower, even more favourably 5 w/w % or lower, and most favorably 3 w/w % or lower. Favourably the concentration of microparticles or fluoropolymers in drilling fluid is 0.1 w/w % or higher, more favourably 0.3 w/w % or higher, even more favourably 0.8 w/w % or higher and most favourably 1.5 w/w % or higher.

It is desirable that the fluorinate polymeric microparticles and/or the fluoropolymers are elastomeric at the well temperatures, which means the microparticles and fluoropolymers have a glass transition temperature (Tg) which is lower than the well temperature. The particular glass transition temperature of the microparticles and fluoropolymers of additives described herein can be suitably selected in light of the particular drilling operation (e.g. the well temperature) so that the microparticles and/or fluoropolymers of an additive are elastomeric at the particular well temperature and, accordingly, under the particular drilling operation conditions. It may be favourable to generally match (in so far as possible) additives to a particular drilling operation at hand and conditions of that particular drilling operation, in particular as related to fluid loss so that the glass transition temperature of microparticles and/or fluoropolymers is high as possible relative to the particular well/drilling operation conditions, while at the same time the glass transition temperature is such that the elastomeric nature of the microparticles and/or fluoropolymers within the drilling fluid under the particular well/drilling operation conditions is ensured. Additives described herein may be advantageously provided in a variety of grades, wherein the grades may have different glass transition temperatures and different compositions.

Additives may further comprise an antioxidant to further increase temperature resistance of microparticles. Useful anti-oxidants include antioxidants selected from the group consisting of primary anti-oxidants, secondary anti-oxidants, multi-functional anti-oxidants, hydroxylamines, carbon-centered radical scavengers and mixtures thereof.

Examples include those available under the trade designations IRGANOX (from Ciba Specialty Chemicals, Brussels, Belgium), SUMILIZER (Sumitomo Chemical, Machelen, Belgium) and mixtures thereof.

For ease in use and addition to a drilling fluid, preferably additives are provided in a dry form (e.g. mircoparticles and/or fluoropolymers provided in the form of a dry powder) or in the form of a suspension where the fluoropolymer-containing microparticles and/or the fluoropolymers are dispersed in a liquid. For additives provided in the form of a suspension, the fluoropolymer-containing microparticles and/or the fluoropolymers are favourably suspended in water, in a solvent, such as a hydrocarbon solvent (e.g. ethyl acetate, tetrahydrofuran, heptane, 2-butanone, benzene, cyclohexane, C10-C20 hydrocarbon or a mixture thereof), or in an oil, more favourably in a solvent or in an oil, and most favorably in a solvent. Typically such a suspension has a solid content (relative to the fluoropolymer-containing microparticles and/or fluoropolymers) of at least 10% by weight, more particular at least 40% by weight. Such a suspension may have solid content up to 70% by weight (based on the total weight of the suspension).

Drilling Fluids:

As mentioned above, additives described herein are particularly advantageous in that they are favorably suitable for use in various drilling fluids and various types of drilling fluids, such as water-based drilling fluids or organic-based drilling fluids (e.g., oil-based drilling fluids or so-called synthetic-based drilling fluids). Accordingly drilling fluids comprising an additive as described herein may be inter alia water-based drilling fluids or organic-based drilling fluids, such as oil-based drilling fluids, synthetic-based drilling fluids or other organic-based drilling fluids. Additives described herein are particularly favorable for use in controlling fluid loss of organic-based drilling fluids, such as oil-based drilling fluids and synthetic-based drilling fluids as well as other types of organic based drilling fluids). Particularly favorable drilling fluids comprising an additive as described herein include organic-based drilling fluids, such as oil-based drilling fluids, synthetic-based drilling fluids or other organic-based drilling fluids.

A water-based drilling fluid typically includes water/aqueous liquid, forming a continuous phase of the drilling fluid. Water may be for example fresh water, sea water, brine and mixtures thereof. Water-based drilling fluids may also comprise viscosity builders (e.g. clays, such as bentonite and sepiolite, or polymers, such as celluloses, xanthan gum and polyacrylamides); rheological control agents (e.g. dispersants, such as polyphosphates, tannins, lignites or lignosulfonates, or surfactants); weighting agents (such as barite, hematite, magnetite, siderite, dolomite, calcite or sodium chloride); and/or other additives known in the art, such as hydrate suppressors. Water-based drilling fluids typically comprise aqueous phase, reactive solids and inert solids. Solid weighting agents such as barite or hematite are typically chemically inactive/inert, while reactive solids may include viscosity-builder clays or incorporated hydratable clays and shales from drilled formation. Polymeric viscosity builders and rheological control agents may be suspended or dissolved in the aqueous phase. Water-based drilling fluids may also include other water soluble organic compounds, such as hydrate suppressors (e.g. low molecular weight (2000 g/mol or lower) glycols, polyglycols, polyalkyleneoxides, alkyleneoxide copolymers, alkylene glycol ethers, polyalkyleneoxide glycol ethers, carbohydrates, amino acids, amino sulfonates and alcohols comprising between about 1-3 carbon atoms as well as salts thereof). Water-based drilling fluids may also comprise an oil-in-water emulsion (e.g. up to 25% by weight of an oil in water in the presence of an emulsifier). Organic-based drilling fluids typically include an organic fluid as a continuous phase. Organic-based drilling fluids include among others oil-based drilling fluid and synthetic-based drilling fluids. Oil-based drilling fluids are typically based on a petroleum oil, e.g. crude oil, diesel oil, biodiesel oil, kerosene, mineral oil, gasoline, naphtha, toluene or mixtures thereof. Oil-based drilling fluids most often comprise diesel oil or mineral oil. Oil-based drilling fluids may be “all-oil mud” (i.e. oil-based drilling fluids comprising no or very low amounts of water (less than 10% by volume of an aqueous phase)) or an “invert oil-emulsion mud” (oil-based drilling fluid comprising higher amounts of water (up to 70% by volume of an aqueous phase)). Synthetic-based drilling fluids generally comprise a fluid, in particular oleaginous fluid, derived from olefins, linear alpha-olefins, poly alpha-olefins, internal esters and ethers; siloxanes such as polydiorganosiloxanes or organosiloxanes; paraffins such as linear or branched paraffins; and mixtures thereof. Synthetic-based drilling fluids are similar to oil-based drilling fluids and often referred to “pseudo-oil muds”. Similar to the oil-based drilling fluids, synthetic-based drilling fluid may be provided as invert emulsion type mud (e.g. comprising up to 70% by volume of an aqueous phase). Oil-based or synthetic-based drilling fluids, may also comprise viscosity builders (e.g. organophilic clays prepared from bentonite or hectorite and aliphatic amine salts, or colloidal asphalt or polymers, such as celluloses, xanthan gum and polyacrylamides); rheological control agents (e.g. dispersants, such as polyphosphates, tannins, lignites or lignosulfonates, or surfactants); weighting agents (such as barite, hematite, magnetite, siderite, dolomite, calcite or sodium chloride); and/or other additives known in the art. Other organic-based drilling fluids include drilling fluids in which the base fluid is based on a polyfunctional alcohol or polyfunctional alcoholic derivative, such as glycols, polyglycols, polyoxyalkylene, glycol ethers, glycol esters and mixtures thereof. Such organic-based drilling fluids may also comprise viscosity builders (e.g., polymers, such as celluloses, xanthan gum, gar gum, polyacrylamides and starches); rheological control agents (e.g. dispersants); weighting agents; and/or other additives known in the art. In drilling fluids comprising an additive as described herein suitably the concentration of microparticles is sufficient to reduce fluid loss having regard to the particular drilling operation, subterranean formation and causes for drilling fluid loss.

Therefore, there are also provided compositions comprising the microparticles and/or fluoropolymers described herein and one or more liquid hydrocarbon containing from 8 to 30, or from 10 to 20 carbon atoms, glycol, polyglycol and/or a siloxane.

This disclosure presents the invention by way of representation and not limitation. It should be understood that numerous other modifications and embodiments can be devised by those skilled in the art which fall within the scope and spirit of the principles of this invention.

### EXAMPLES

Materials:

AA: Acrylic acid (from Sigma-Aldrich, Switzerland);

BDDA: Butanediol diacrylate (Laromer BDDA, BASF, Germany);

EHA: 2-Ethylhexyl acrylate (Nippon Skokubai, Japan);

FC-2145: Fluoroelastomer (copolymer of VDF and HFP, 65.9% F, available from Dyneon GmbH, Burgkirchen, Germany);

IBOA: Isobornylacrylate (Osaka Organic, Kashiwara, Japan);

LUPEROX A75: Benzoylperoxide (Atofina);

MeFBSEA 3-N-methylperfluorobutanesulfonamidoethyl acrylate, prepared according to example 2, part A and B of U.S. Pat. No. 6,664,354 to Savu;

MMA: Methacrylmethacrylate (Lucite, Billingham, UK);

STANDAPOL A Lauryl sulphate (Cognis, Germany);

SPIDRIL 2: base oil used in drilling fluids obtained from SIP, London, UK;

SUREMUL EH: oil wetting agent, obtained from MI Swaco, Stavanger, Norway;

VERSAVERT: drilling fluid from M-I Swaco, Stavanger, Norway;

WAKO V65 2,2′-Azobis(2,4-dimethyl)valeronitrile (Wako Specialty Chemicals).

1. Synthesis of Microparticles Containing Fluoropolymer: General Procedure A

Several microparticles containing fluoropolymer were prepared according to the general procedure A as given for the synthesis of EHA/AA/BDDA (97.5/2/0.5)-microparticles containing 10% by weight fluoropolymer.

a. EHA/AA/BDDA (97.5/2/0.5)-Microparticles Containing 10% by Weight Fluoropolymer (Used in Example 1)

A 4 liter reactor, equipped with a mechanical stirrer and a heating unit, was charged with 1800 g of deionised water, 51.4 g of ammonium lauryl sulphate (Standapol A, Cognis Germany) and 24 grams of acrylic acid (AA). The agitation was set to 200 rpm and the reactor was heated to 35° C. A glass flask was charged with 120 grams FC 2145 and 1170 grams of ethyl hexyl acrylate (EHA). After sealing, the flask was rolled during 16 hours at room temperature. A homogeneous phase without gels was obtained. This mixture was transferred to a beaker containing a mixture of 6 grams butane diol diacrylate (BDDA, Laromer BDDA from BASF), 4.22 grams benzoylperoxide (Luperox A75 from Atofina) and 0.79 grams of 2.2′-Azobis(2,4-dimethyl)valeronitrile (Wako V65 from Wako Specialty Chemicals). The mixture was stirred for 15 min. This organic phase was then added to the reactor. The temperature was set at 55° C. and the mixture was stirred at 600 rpm for 2 hours under an air atmosphere. Then the air supply was switched to nitrogen and the reaction was further stirred during 6 hours. After this period the reaction mixture was allowed to cool to room temperature and filtered over a cheese cloth to remove the coagulum. Microparticles having a Tg of −71° C. were obtained.

b. EHA/AA/BDDA (97.5/2/0.5)-Microparticles Containing 20% Fluoropolymer (Used in Examples 2 to 5)

EHA/AA/BDDA (97.5/2/0.5)-microparticles containing 20% by weight FC 2145 were made in the same way, but using 240 grams FC 2145 instead of 120 grams.

In example 2 the microparticles were used as received from the reactor (having a solid content of 40% in water).

In example 3 were settled out and the water phase was removed by decanting. The remaining product was used as an aqueous paste.

In example 4 the microparticles were precipitated by adding isopropanol to the aqueous dispersion (50/50 by volume). The precipitate was filtered over a Buchner funnel and washed with water. The wet particles were dried in a vacuum oven at 50° C. for 6 hours. The microparticles were used as solids.

In example 5 dried microparticles were dispersed in SPIDRIL 2.0 (20% wt) to which 2.0% wt SUREMUL EH were added- The mixture was stirred in a high speed blender for 10 minutes).

c. EHA/IBOA/AA/BDDA (47.5/50/2/0.5)-Microparticles Containing 20% Fluoropolymer, Used in Example 6

EHA/IBOA/AA/BDDA (47.5/50/2/0.5)-microparticles containing 20% FC 2145 were made according to the general procedure A except that 240 grams FC 2145 was mixed with 570 grams EHA and 600 grams IBOA. Microparticles having a Tg of −21° C. were obtained.

d. EHA/MMA/AA/BDDA (77.5/20/2/0.5)-Microparticles Containing 10% Fluoropolymer (Used in Example 7)

EHA/MMA/AA/BDDA (77.5/20/2/0.5)-microparticles containing 10% FC 2145 was made according to general procedure A except that 120 grams FC 2145 was mixed with 930 grams EHA and 247.5 grams methylmethacrylate (MMA). Microparticles having a Tg of −50° C. were obtained.

e. EHA/IBOA/AMPS/BDDA (76.5/20/2/1.5)-Microparticles Containing 20% Fluoropolymer (Used in Example 8)

EHA/IBOA/AMPS/BDDA (76.5/20/2/1.5)-microparticles containing 20% FC 2145 were made according to the general procedure A, with the exception that 24 g of 2-acrylamido-2-methyl-1-propane sulfonic acid (AMPS) was used instead of AA. The microparticles were further made with 240 grams FC2145, 918 grams EHA, 240 grams IBOA and 18 grams BDDA. The resulting microparticles had a Tg of −47° C.

2. Synthesis of Fluorinated Polymeric Microparticles Containing Fluorinated Comonomers, General Procedure B:

Fluorinated polymeric microparticles were made according to the general procedure B as is given for EHA/AA/BDDA/MeFBSEA (92.5/2/0.5/5)-microparticles.

a. EHA/AA/BDDA/MeFBSEA (92.5/2/0.5/5)-Microparticles (Used in Example 9):

A 4 liter reactor, equipped with a mechanical stirrer and a heating unit, was charged with 1800 grams of deionised water, 51.4 grams of ammonium lauryl sulphate and 24 grams of acrylic acid. The agitation was set to 200 rpm and the reactor was heated to 35° C. A glass flask was charged with 60 grams MeFBSEA and 1146 grams EHA, sealed and rolled during 6 hours at room temperature. Then this monomer mixture was transferred to a beaker containing 6 grams BDDA, 4.0 grams Luperox A75, and 1.0 grams of Wako V65. The mixture was stirred for 15 min. This organic phase was added to the reactor and the procedure was identical to general method A described above. The Tg of the microparticles was −71 ° C.

b. EHA/IBOA/AA/BDDA/MeFBSEA (77.5/10/2/0.5/10)-Microparticles (Used in Example 10)

EHA/IBOA/AA/BDDA/MeFBSEA (77.5/10/2/0.5/10)-microparticles were made according to the same procedure B with the exception that 117 grams MeFBSEA, 936 grams EHA and 117 grams IBOA were used. The Tg was −52° C.

3. Synthesis of Comparative Microparticles: General Procedure C

Several comparative microparticles were prepared according to the general procedure C as is given for the synthesis of EHA/BDDA(99.5/0.5)-microparticles:

a. EHA/BDDA (99.5/0.5)-Microparticles (Used in Comparative Example C-1)

A 4 liter reactor, equipped with mechanical stirrer and a heating unit was charged with 1800 grams of deionised water and 51.4 grams of ammonium lauryl sulphate. The agitation was set to 200 rpm and the reactor was heated to 65° C. In a separate flask 1194 grams of EHA, 6 grams BDDA, 4.22 grams of Luperox A75 and 0.79 grams Wako V65 were stirred during 15 min. Then this organic phase was added to the reactor. The temperature was set at 55° C. and the mixture was stirred at 600 rpm for 2 hours under an air atmosphere.

Then the air supply was switched to nitrogen and the reaction was further stirred during 6 hours. After this period the reaction mixture was allowed to cool to room temperature and filtered over a cheese cloth to remove the coagulum. Hollow microparticles having a mean particle diameter of about 47 microns were obtained. The Tg was −50° C.

b. EHA/AA/BDDA (97.5/2/0.5)-Microparticles (Used in Comparative Example C-2)

EHA/AA/BDDA (97.5/2/0.5) microparticles were made in the same way except that 24 grams of acrylic acid (AA) was charged together with the ammonium lauryl sulphate. 1170 grams EHA were used instead of 1194 grams. The reaction conditions were the same as described above. Hollow microparticles having a mean particle diameter of about 50 microns were obtained. The Tg was −50° C.

c. EHA/IBOA/AA/BDDA (77.5/20/2/0.5)-Microparticles (Used in Comparative Example C-3)

EHA/IBOA/AA/BDDA (77.5/20/2/0.5)-microparticles were made according to the general procedure B as outlined above, except that 24 grams of acrylic acid (AA) was charged together with the ammonium lauryl sulphate. Further, 930 grams EHA, 240 g isobornylacrylate (IBOA) and 6 g BDDA were used. The reaction conditions were the same as described above. Hollow microparticles having a mean particle diameter of about 50 microns were obtained. The microparticles had a Tg of −47° C.

Fluid Loss Measurements

For fluid loss testing, drilling fluid as obtained (VERSAVERT from M-I Swaco, Stavanger, Norway, which is a mineral oil based drilling fluid) without a fluid loss additive (Reference), drilling fluids to which fluorinated polymeric microparticles have been added as fluid-loss additive and drilling fluids to which a fluoropolymer has been added as fluid loss additive (Example) were compared with drilling fluid to which acrylate microparticles had been added as fluid loss additives (Comparative). The additives were added as aqueous dispersions to the drilling fluid at a concentration as indicated in table 1 (expressed as concentration [wt%] which corresponds to the weight of microparticles or fluoropolymer to total weight of drilling fluid). The concentration of microparticles or fluoropolymer in the dispersion is indicated as solids content [% wt], which corresponds to the weight of the microparticles or the fluoropolymer to total weight of the dispersion. A solids content of 100% indicates the microparticles or fluoropolymers were added as a dry powder and not as dispersions.

The drilling fluid compositions were aged in a roller oven at 175° C. (unless indicated otherwise) for 16 hours under a pressure of 200 psi nitrogen according to API Recommended Practice 131/25.8 “Procedure for Hot Rolling”.

Fluid loss was measured at 150° C. and a pressure difference of 500 psi using an OFITE HTHP Filter Press (OFI Testing Equipment, Houston, US) using OFITE 170-19 filter paper (2.7 micron pores) according to API 13B-2 Recommended Practice for Field Testing Oil-Based Drilling Fluids. Filtrate was collected over a period of 30 minutes. The volume collected (filtrate volume after 30 minutes, FV 30) is a measure for fluid loss. The lower the FV30 the better the filter is sealed by the additive and the lower is the fluid loss. The results are shown in table 1.

Particle Size Measurements

Particle sizes of the microsphere were measured using a particle size measurement device from Particle Sizing System Inc (Santa Barbara, USA) using intensity weighted Gaussian distribution analysis. The particle size is expressed in microns and represent the number average.

Volume Swell Factor

The swell volume can be measured as follows: 10 ml dry microparticles are added to 100 ml test liquid (e.g. water, liquid hydrocarbon, respectively) at the test temperature, removing the particles from the test liquid after one hour (for example by filtration or centrifugation and measuring the volume taken up by the microparticles using a measuring cylinder having a scale indicating at least 10 ml intervals. The volume increase is then converted into the volume swell factor. When the volume has not increased, i.e. it has remained at 10 ml, the volume swell factor is 1.0. When the volume has doubled to 20 ml, the volume swell factor is 2.0. When the volume has tripled (30 ml) the volume swell factor is 3.0.

### Examples 1 to 11

| | | | | Fluid |
|---|---|---|---|---|
| | | | | Volume |
| | | Solids | Conc. | (FV30) |
| | Additive | [%] | [wt. %] | [ml] |
| Reference | No additive | | | 40 |
| C-1 | EHA/BDDA | 40 | 1.5 | 4 |
| | (99.5/0.5)- | | | |
| | microparticle, | | | |
| | aged at 120° C. | | | |
| C-2 | EHA/AA/BDDA | 40 | 1.5 | >30 |
| | (97.5/2/0.5)- | | | |
| | microparticle, | | | |
| | aged at 150° C. | | | |
| C-3 | EHA/IBOA/AA/BDDA | 100 | 1.0 | >50 |
| | (77.5/20/2/0.5)- | | | |
| | microparticle | | | |
| Ex 1 | EHA/AA/BDDA | 40 | 1.0 | 12 |
| | (97.5/2/0.5)- | | | |
| | microparticle | | | |
| | containing 10% | | | |
| | fluoropolymer | | | |
| Ex 2 | EHA/AA/BDDA | 40 | 1.0 | 8 |
| | (97.5/2/0.5)- | | | |
| | microparticle | | | |
| | containing 20% | | | |
| | fluoropolymer | | | |
| Ex 3 | EHA/AA/BDDA | 60 | 1.0 | 10 |
| | (97.5/2/0.5)- | | | |
| | microparticle | | | |
| | containing 20% | | | |
| | fluoropolymer | | | |
| Ex 4 | EHA/AA/BDDA | 100 | 0.5 | 18 |
| | (97.5/2/0.5)- | | | |
| | microparticle | | | |
| | containing 20% | | | |
| | fluoropolymer | | | |
| Ex 5 | EHA/AA/BDDA | 20 | 1.0 | 10 |
| | (97.5/2/0.5)- | | | |
| | microparticle | | | |
| | containing 20% | | | |
| | fluoropolymer | | | |
| Ex 6 | EHA/IBOA/AA/BDDA | 100 | 1.0 | 10 |
| | (47.5/50/2/0.5)- | | | |
| | microparticles | | | |
| | containing 20% | | | |
| | fluoropolymer | | | |
| Ex 7 | EHA/MMA/AA/BDDA | 40 | 1.0 | 12 |
| | (77.5/20/2/0.5)- | | | |
| | microparticles | | | |
| | containing 10% | | | |
| | fluoropolymer | | | |
| Ex 8 | EHA/IBOA/AMPS/BDDA | 100 | 1.0 | 8 |
| | (76.5/20/2/1.5)- | | | |
| | microparticles | | | |
| | containing 20% | | | |
| | fluoropolymer | | | |
| Ex 9 | EHA/MeFBSEA/BDDA | 40 | 1.0 | 12 |
| | (92.5/2/0.5/5)- | | | |
| | microparticles | | | |
| Ex 10 | EHA/IBOA/MeFBSEA/BDDA | 60 | 1.0 | 23 |
| | (77.5/10/2/0.5/10)- | | | |
| | microparticles | | | |
| Ex 11 | Fluoropolymer | 100 | 1.0 | 24 |
| | (FC-2145) | | | |

1. Fluorinated polymeric microparticles comprising one or more repeating units derived from one or more fluorinated monomers and one or more repeating units derived from one or more acrylate monomers.

2. The microparticles according to claim 1 having a diameter of from about 0.1 micron to about 100 microns.

3. The microparticles according to claim 1, wherein the microparticles are not soluble in water and not soluble in a liquid hydrocarbon containing from 10 to 20 carbon atoms.

4. The microparticles according to claim 1 having a volume swell factor of less than 4.

5. The microparticles according to claim 1 being thermostable up to at least 175° C.

6. The microparticles according to claim 1 wherein the microspheres are cross-linked.

7. The microparticles according to claim 1 wherein the acrylate monomer is an acrylate ester represented by the general formula
R—O—CO—C(R₁)═C(R₂)(R₃), wherein
R is a is a linear, branched or cyclic hydrocarbon, which may be non-substituted or substituted with oxygen, nitrogen, halogen, sulphur atoms and aromatic residues and combinations thereof;
R₁ represents hydrogen, halogen, or a lower alkyl group having from 1 to 4 carbon atoms,
R₂, and R₃ may be identical or different and represent, independently from each other, hydrogen or a linear or branched alkyl group.

8. The microparticles according to claim 1 wherein the acrylate monomer is an ester of acrylic acid or methacrylic acid and a non-tertiary alkyl alcohol, the alkyl group of which has from 4 to 20 carbon atoms.

9. The microparticles according to claim 1 wherein the acrylate monomer is selected from the group consisting of isooctyl acrylate, 4-methyl-2-pentyl acrylate, 2-methylbutyl acrylate, isoamyl acrylate, sec-butyl acrylate, n-butyl acrylate, 2-ethylhexyl acrylate, isodecyl methacrylate, isononyl acrylate, isodecyl acrylate, isobornyl acrylate, and combinations thereof

10. The microparticles according to claim 1 further comprising
one or more repeating units derived from a comonomer that is copolymerisable with the acrylate monomer and that is selected from the group consisting of ethylenically unsaturated monocarboxylic and dicarboxylic acids and salts thereof, ethylenically unsaturated monosulfonic acids and salts thereof, acrylamides, methacrylamides, acrylonitriles, vinyl-, or acrylate-terminated poly(alkylene oxides), vinylchlorides, styrenes, N-vinylpyrrolidone and combinations thereof.

11. The microparticles according to claim 1 wherein the fluorinated monomer corresponds to the general formula
X₂C=CXZ
wherein each X may be the same or different and is selected from the group consisting of H, F and Cl, with the proviso that at least one X represents F, and Z represents H, F, Cl, Br, I, Rf′, or —O—CO—Rf′, wherein Rf′ represents a residue containing one or more fluorine atoms.

12. The microparticles according to claim 1 wherein the fluorinated monomer is co-polymerisable with the acrylate monomer.

13. The microparticles according to claim 1 wherein the fluorinated monomer that is copolymerisable with the acrylate monomer is represented by the general formula
R_{f}—O—CO—C(R′₁)═C(R′₂)(R′₃),
wherein Rf represents a fluorinated residue R′₁ represents a hydrogen, halogen or a lower alkyl group having 1 to 4 carbon atoms and R′₂, and R′₃ may be identical or different and represent, independently from each other, hydrogen or a linear or branched alkyl group.

14. The microparticles according to claim 1 wherein the repeating units derived from the fluorinated monomers are part of a fluoropolymer and wherein the repeating units derived from an acrylate monomer are part of an acrylate polymer.

15. The microparticles of claim 14, wherein the microparticles comprise from about 1 to about 30% by weight of the fluoropolymer based on the total weight of the microparticle.

16. The microparticles according claim 1 wherein the repeating units derived from the fluorinated monomers and wherein the repeating units derived from the acrylate monomers are comonomers of a fluoro-acrylate copolymer.

17-19. (canceled)

20. A composition comprising the microparticles according to claim 1 further comprising water, a liquid hydrocarbon having from 10 to 20 carbon atoms, a glycol, a polyglycol, a siloxane and combinations thereof.

21. The composition of claim 20, wherein the composition is a drilling fluid.

22. (canceled)

25. A method of reducing fluid loss of a drilling fluid into the material surrounding a borehole generated in a drilling operation, said method comprising adding to the drilling fluid the microparticles according to claim 1 and circulating said drilling fluid during the drilling of borehole.

26. A method of reducing fluid loss of a drilling fluid into the material surrounding a borehole generated in a drilling operation, said method comprising adding to the drilling one or more fluoropolymers and circulating said drilling fluid during the drilling of borehole.
